(19) United States
(12) Patent Application Publication
(10) Pub. No.: US 2012/0153054 A1
(43) Pub. Date: Jun. 21, 2012

(54) MICRO-EJECTING APPARATUS

(75) Inventors: Sang Jin KIM, Suwon (KR); Hee Ju SON, Suwon (KR); Suk Ho SONG, Ansan (KR); Bo Sung KU, Suwon (KR)

(73) Assignee: SAMSUNG ELECTRO-MECHANICS CO., LTD.

(21) Appl. No.: 13/240,385

(22) Filed: Sep. 22, 2011

(30) Foreign Application Priority Data
Dec. 20, 2010 (KR) 10-2010-0130715

(51) Int. Cl. F02M 51/00

(52) U.S. Cl. 239/585.1

(57) ABSTRACT

There is provided a micro-ejecting apparatus. The micro-ejecting apparatus includes: an ejector including a channel therein and a driving part for ejecting a fluid to the outside; a body including a plurality of mounting parts on which the ejector is mounted; and guiding members fixed on the body and corresponding to the plurality of mounting parts so as to determine the positions of the plurality of mounting parts in the body.

### CROSS-REFERENCE TO RELATED APPLICATIONS

This application claims the priority of Korean Patent Application No. 10-2010-0130715 filed on Dec. 20, 2010, in the Korean Intellectual Property Office, the disclosure of which is incorporated herein by reference.

### BACKGROUND OF THE INVENTION

1. Field of the Invention

The present invention relates to a micro-ejector, and more particularly, to a micro-ejecting apparatus on which a micro-ejector can be stably mounted.

2. Description of the Related Art

Biotechnology is one of the most prominent fields among highly-developed modern high-technologies. In biotechnology, samples directly or indirectly related to the life of organisms are largely used. Therefore, a micro-liquid system performing the transporting, controlling and analyzing of a fluid (particularly, a micro-fluid sample dissolved in a medium) is necessary.

The micro-liquid system is manufactured based on Micro Electro Mechanical Systems (MEMS) technology. The micro-liquid system is applied to various fields such as the vivo-injection of drugs or bioactive substances, a lab-on-a-chip, a chemical analysis for a new drug development, an inkjet printer, a small cooling system, a small fuel cell, and the like.

One of the micro-fluid systems used in those fields is a micro-ejecting apparatus. In this case, since a medical micro-ejecting apparatus deals with high-viscosity and conductive liquids, particular cautions are required in using the apparatus.

The micro-ejecting apparatus is provided with an ejector quantitatively ejecting the micro-fluid. The ejector is mounted on a mounting hole formed in the micro-ejecting apparatus.

However, in general, since the ejector has an elongated shape, the ejector may be easily broken when being inserted into the mounting hole of the micro-ejecting apparatus.

Further, since the mounting hole for the ejector is formed on the bottom of the micro-ejecting apparatus, if a user is not considerably skilled, it may be difficult to exactly mount the ejector into the mounting hole.

### SUMMARY OF THE INVENTION

An aspect of the present invention provides a micro-ejecting apparatus capable of stably mounting the ejector to minimize damage to the ejector.

Further, another aspect of the present invention provides a micro-ejecting apparatus in which a user can easily determine the mounting position of the ejector with the naked eye such that the user can easily mount the ejector.

According to an aspect of the present invention, there is provided a micro-ejecting apparatus including: an ejector including a channel therein and a driving part for ejecting a fluid to the outside; a body including a plurality of mounting parts on which the ejectors are mounted; and guiding members fixed on the body and having guide grooves corresponding to the plurality of mounting parts so as to determine the positions of the plurality of mounting parts in the body.

The guiding groove may be gradually larger toward the lower end from the upper end.

The body may include a channel formed therein, for supplying the fluid to the ejector.

The body may further include a fastening hole formed therein for fixing an external pipe connected with the channel.

The ejector mounted on the mounting part may protrude outside of the guiding member.

The body may further include a power supply substrate for supplying a current or a voltage to the driving part and a connection pin.

The body may include: a first body including the plurality of mounting parts; and a second body connected to a fluid supply part supplying the fluid to the ejector.

One side of the guiding member may be inclined so as not to contact the ejector mounted on the mounting part.

The mounting part may further include a fixing member installed thereon for supporting the ejector.

The mounting part may be a groove having a shape corresponding to the external shape of the ejector.

The mounting part may be opened toward the bottom of the body.

An end of the ejector inserted into the mounting part and an end of the mounting part corresponding thereto may be sharpened so as to align the ejector.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view of a micro-ejecting apparatus according to a first exemplary embodiment of the present invention;

FIG. 2 is a cross-sectional view describing a configuration of the ejector shown in FIG. 1;

FIG. 3 is a partially cut-away front view of a micro-ejecting apparatus illustrating form of amounting part;

FIG. 4 is a front view describing a use example of the micro-ejecting apparatus shown in FIG. 1.

FIG. 5 is an exploded perspective view of a micro-ejecting apparatus according to a second exemplary embodiment of the present invention;

FIG. 6 is a perspective view of the micro-ejecting apparatus shown in FIG. 5;

FIG. 7 is a front view of the micro-ejecting apparatus shown in FIG. 6;

FIG. 8 is a front view of a micro-ejecting apparatus according to a third exemplary embodiment of the present invention; and

FIGS. 9 and 10 are side views of a micro-ejecting apparatus according to a fourth exemplary embodiment of the present invention.

### DETAILED DESCRIPTION OF THE PREFERRED EMBODIMENT

Exemplary embodiments of the present invention will now be described in detail with reference to the accompanying drawings.

The present invention is not limited to the exemplary embodiments and the exemplary embodiments are used to help understanding the spirit of the present invention. Like reference numerals refer to like elements in the accompanying drawings.

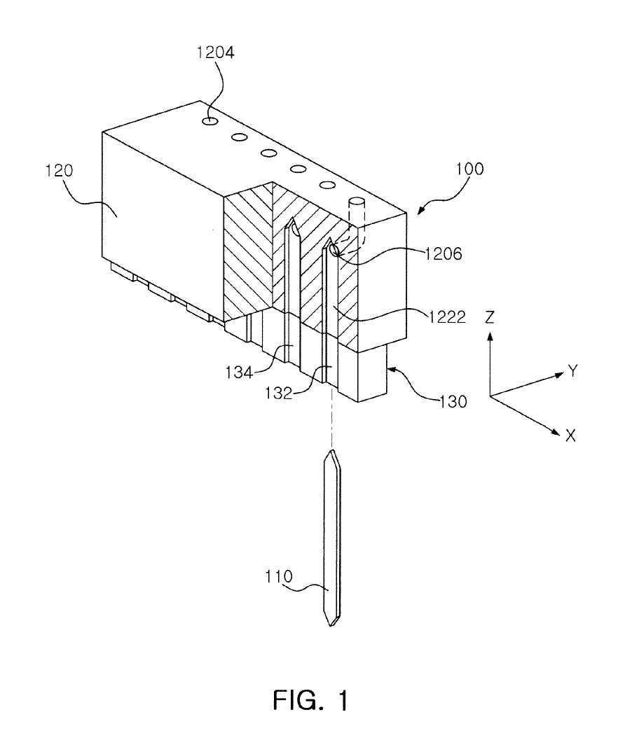

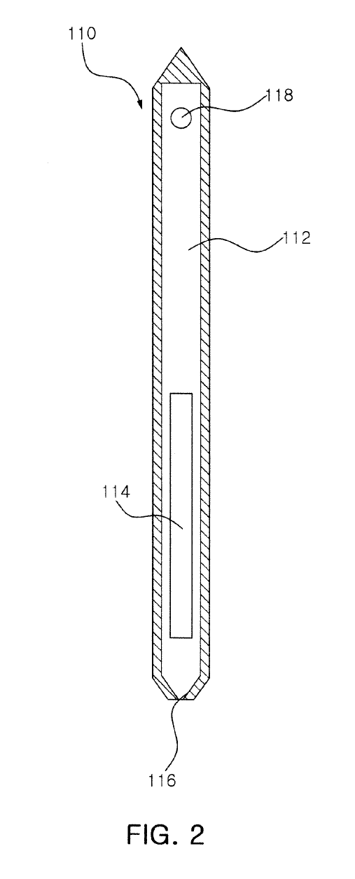

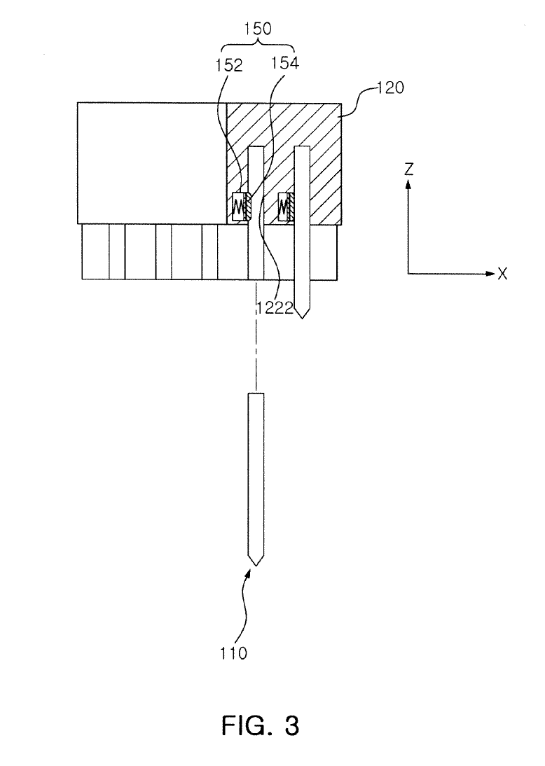

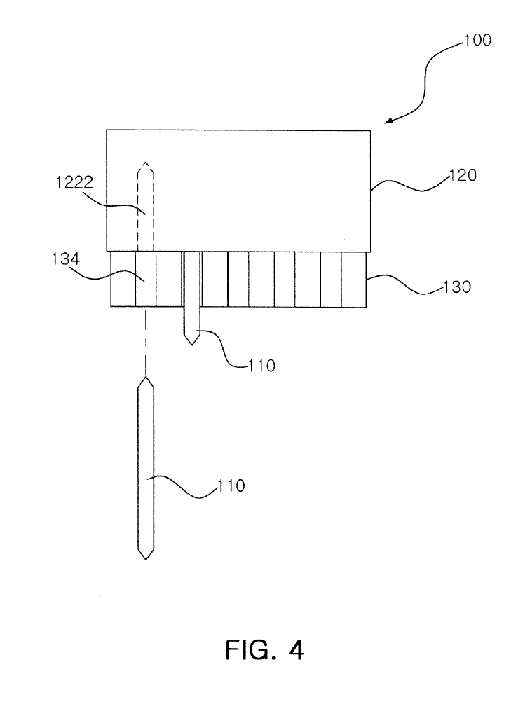

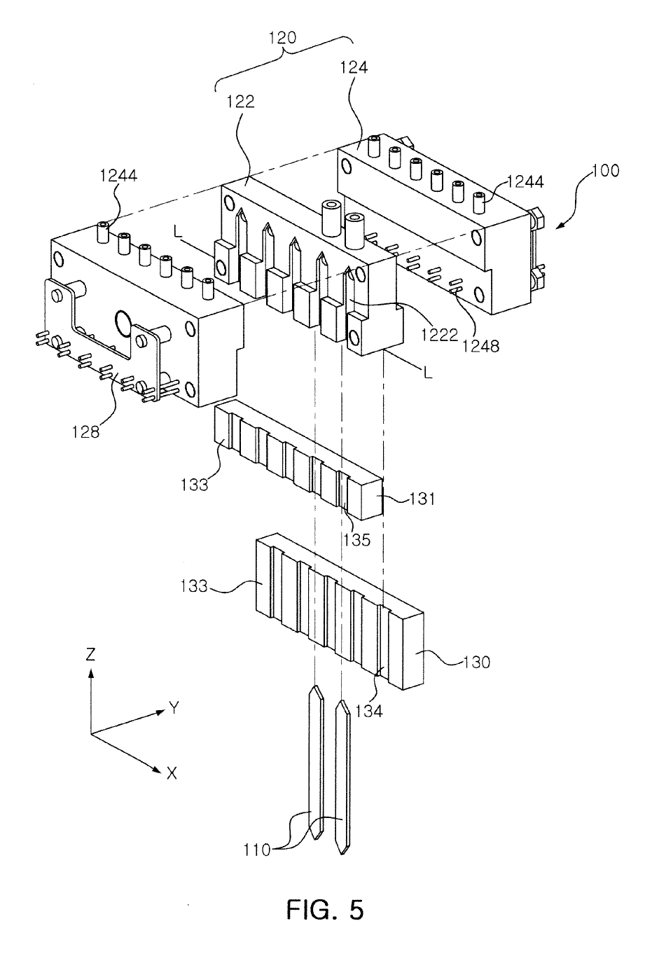

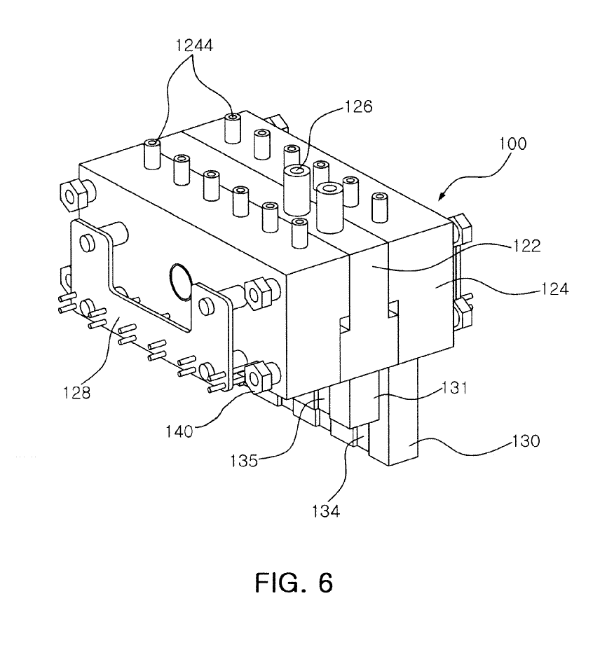

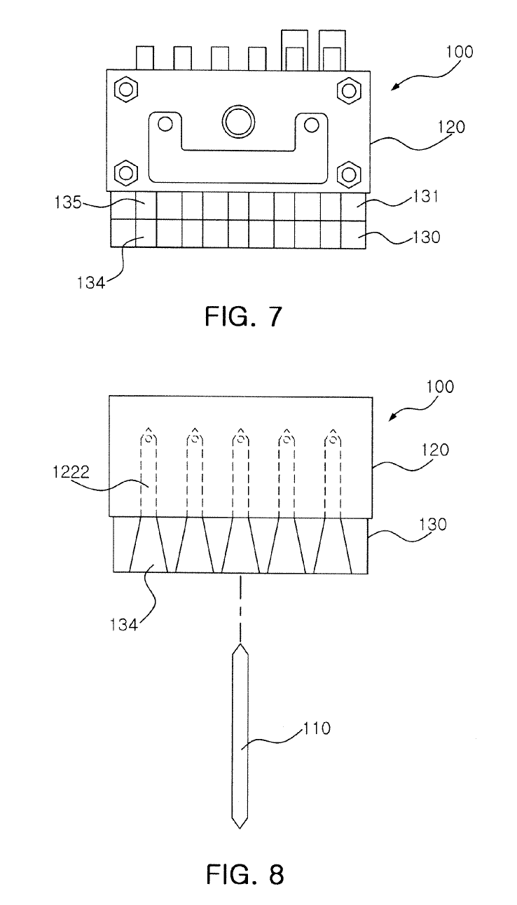

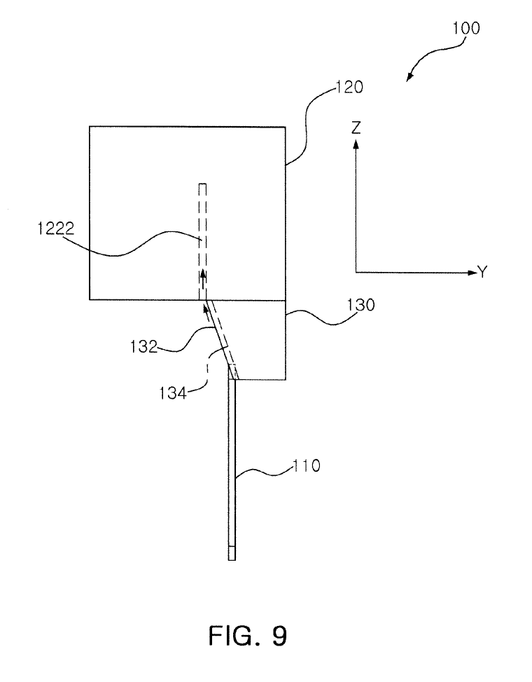

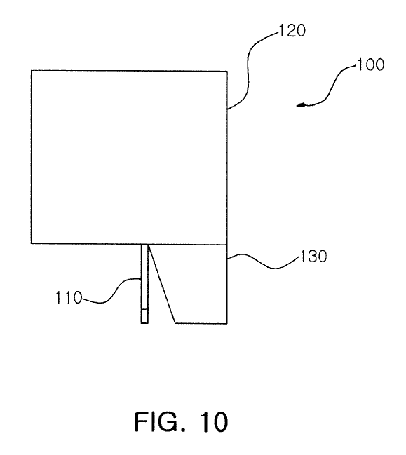

FIG. 1 is a partially cut-away perspective view of a micro-ejecting apparatus according to a first exemplary embodiment of the present invention; FIG. 2 is a cross-sectional view describing a configuration of the ejector shown in FIG. 1; FIG. 3 is a partially cut-away front view of a micro-ejecting apparatus illustrating form of a mounting part; FIG. 4 is a front view describing a use example of the micro-ejecting apparatus shown in FIG. 1; FIG. 5 is an exploded perspective view of a micro-ejecting apparatus according to a second exemplary embodiment of the present invention; FIG. 6 is a perspective view of the micro-ejecting apparatus shown in FIG. 5; FIG. 7 is a front view of the micro-ejecting apparatus shown in FIG. 6; FIG. 8 is a front view of a micro-ejecting apparatus according to a third exemplary embodiment of the present invention; and FIGS. 9 and 10 are side views of a micro-ejecting apparatus according to a fourth exemplary embodiment of the present invention.

### First Exemplary Embodiment

The micro-ejecting apparatus according to the first exemplary embodiment will be described with reference to FIGS. 1 to 4.

The micro-ejecting apparatus 100 according to the exemplary embodiment includes an ejector 110, a body 120, and a guiding member 130 as shown in FIG. 1.

The ejector 110 is a member having an elongated shape as described in the related art. The ejector 110 is detachable to the body 120 and ejects a micro-fluid. The detailed configuration of the ejector 110 will be described with reference to FIG. 2. The ejector 110 has a channel 112 through which the fluid moves in the inside thereof as shown in FIG. 2. An inlet 118 into which the fluid flows is formed at one end of the channel 112 and a nozzle 116 from which the fluid is ejected is formed at the other end thereof. In addition, a driving unit, which compresses the fluid stored in the channel 112 toward the nozzle 116 and which may be a piezoelectric actuator 114 according to the exemplary embodiment, is disposed within the channel 112. The ejector 110 receives the fluid supplied through the inlet 118 and stores the fluid in the channel 112 thereof. In addition, when the piezoelectric actuator 114 is operated by an external signal, the ejector 110 ejects the fluid stored in the channel 112 through the nozzle 116. An upper end of the ejector 110 may have a sharp shape as shown in FIG. 2. The sharp shape of the ejector 110 may be advantageously arranged at the center of the mounting part 1222.

Meanwhile, since the sharp shape of the ejector 110 shown in FIG. 2 is according to the embodiment of the present invention, the shape may vary depending on the intended use of the micro-ejecting apparatus 100. For example, the ejector 110 may be constituted by a silicon on insulator (SOI) wafer having an insulating layer between two silicon layers, or one substrate or more. In addition, the channel may be formed by dry or wet-etching the substrate.

The piezoelectric actuator 114 may be formed to correspond to a pressure chamber on the upper surface of the substrate and include a lower electrode acting as a common electrode, a piezoelectric layer deformed depending on an applied voltage, and an upper electrode acting as a driving electrode.

The lower electrode may be formed entirely on the surface of the substrate and made of a single conductive material such as a metal, but preferably may be formed of two metal thin film layers made of titanium (Ti) and platinum (Pt). The lower electrode acts as a diffusion barrier preventing the diffusion between the piezoelectric layer and the substrate and also acts as the common electrode.

The piezoelectric layer may be formed on the lower electrode and disposed on the top of the pressure chamber. The piezoelectric layer may be made of a piezoelectric material, preferably a lead zirconate titanate (PZT) ceramic material. The upper electrode may be formed on the piezoelectric layer and made of any one of Pt, Au, Ag, Ni, Ti, Cu, or the like.

The body 120 may constitute the entire shape of the micro-ejecting apparatus 100. The body 120 may configured to include a plurality of mounting parts 1222, inlets 1204, and outlets 1206.

The mounting part 1222 may have a shape elongated from the bottom of the body 120 to the inner side. The mounting part 1222 is in a groove shape housing a part of the ejector 110. The plurality of mounting parts 1222 are formed at regular intervals in a horizontal direction (X-axial direction) of the body 120. Ends of the plurality of mounting parts 1222 have a sharp shape respectively corresponding to the ends of the ejectors 110 as shown in FIG. 1. The ejector 110 corresponding to the shape of the mounting part 1222 may be positioned inside the mounting part 1222. Therefore, according to the embodiment of the present invention, the interval among the plurality of ejectors 110 respectively disposed in the mounting parts 1222 is uniform.

Meanwhile, the mounting part 1222 may include a fixing member 150 as shown in FIG. 3 in order to contact the ejector 110 to one side wall of the mounting part 1222. The fixing member 150 may include a contact member 152 and a spring 154 and is installed on the side wall of the mounting part 1222. Herein, the spring 154 pushes the contact member 152 in a vertical direction (X-axial direction) substantially with respect to a mounting direction of the ejector 110. In addition, the contact member 152 pushes the ejector 110 to one side of the ejector 110 by an elastic force of the spring 154. Since the ejectors 110 are arranged to one side wall of the mounting part 1222 by the operation of the fixing member 150, the intervals (that is, pitches) between the plurality of ejectors 110 are regular. In the case where the fixing member 150 is included according to the embodiment of the present invention, the end of the ejector 110 may be not formed in a sharp shape shown in FIG. 3.

The inlet 1204 may be formed on the external surface of the body 120. A separate pipe (pipe, horse, etc.) supplying the fluid may be installed in the inlet 1204 and connected with the outlet 1206 through the channel (not shown) formed in the body 120.

The outlet 1206 is formed to meet the mounting part 1222. The outlet 1206 is connected with the inlet 118 in the state in which the ejector 110 is mounted in the mounting part 1222. Accordingly, when the fluid is supplied through the inlet 1204 of the body 120, the fluid flows into the ejector 110 through the outlet 1206. Meanwhile, when the fluid moves from the outlet 1206 to the inlet 118, a sealing member may be further installed on the outlet 1206 or the inlet 118 such that the fluid is not leaked from the connection portion of the outlet 1206 and the inlet 118.

A guiding member 130 may be formed in an elongated shape in a downward direction of the body 120. A number of guiding grooves 134, equal to the number of mounting parts 1222 may be formed on one side 132 of the guiding member 130. The guiding groove 134 longitudinally extends in the same direction as the extended direction of the mounting part 1222 and is continuously connected with the corresponding mounting part 1222. The guiding groove 134 guides the ejector 110 into the mounting part 1222. Meanwhile, the guiding member 130 extended to the body 120 is described above, but may be a single component separable from the body 120.

The characteristics of the micro-ejecting apparatus 100 constituted as described above will be described referring to FIG. 4.

In general, in the micro-ejecting apparatus as described above, since the entrance of the mounting part 1222 is formed at the bottom of the body 120, the position of the mounting part 1222 may be not verified with the naked eye from a direction in the front of the micro-ejecting apparatus.

However, in the micro-ejecting apparatus 100 according to the exemplary embodiment, the position of the mounting part 1222 may be verified with the naked eye through the guiding member 130 extending downward the body 120 as shown in FIG. 4. That is, since a plurality of guiding grooves 134 are formed to be coincident with the position of the mounting parts 1222 at one side of the guiding member 130, the position of the mounting part 1222 may be verified by the position of the guiding groove 134.

Further, in the exemplary embodiment, since the guiding groove 134 and the mounting part 1222 are continuously connected, the ejector 110 can be inserted to the mounting part 1222 by pushing up simply the ejector 110 along the guiding groove 134.

Therefore, according to the exemplary embodiment, the ejector 110 which is fragile can be easily and exactly mounted at the mounting part 1222.

Meanwhile, the ejector 110 mounted at the body 120 may be disposed to protrude downward of the guiding member 130

### Second Exemplary Embodiment

Hereinafter, a micro-ejecting apparatus according to a second exemplary embodiment of the present invention will be described with reference to FIGS. 5 to 7. The micro-ejecting apparatus 100 according to the second exemplary embodiment is different from the first exemplary embodiment in that a shape of the body 120 is different therefrom and a substrate 128 for applying a power source is provided. For reference, the same reference numerals refer to the same components as the first exemplary embodiment and a detailed description for the same components will be omitted.

The micro-ejecting apparatus 100 of the third exemplary embodiment includes a body 120 constituted by a plurality of components and a substrate 128 for applying a power source.

The body 120 may include a first body 122 and two second body 124. The first body 122 includes a mounting part 1222. The mounting part 1222 is formed on the front and the rear of the first body 122, respectively. Two second bodies 124 are respectively formed on the front and the rear of the first body 122. Each second body 124 includes an inlet 1244 and an outlet 1246. The inlet 1244 is formed on an upper part of the second body 124 and connected with the outlet 1246 through a channel (not shown). The outlet 1246 is formed on a surface (front or rear) of the second body 124 facing the first body 122. Herein, the formed position of the outlet 1246 is determined so as to be connected with the inlet 118 of the ejector 110.

Meanwhile, the second body 124 may include the substrate 128 for applying the power source and a connection pin 1248. The substrate 128 for applying the power source is positioned on a surface of the second body 124 which does not face the first body 122. The substrate 128 for applying the power source is connected to an external apparatus to generate a current or a voltage having a uniform intensity. The connection pin 1248 is disposed on a surface facing the first body 122. The connection pin 1248 is connected with the substrate 128 for applying the power source disposed opposite thereto and transmits the current or voltage having a uniform intensity generated from the substrate 128 for applying the power source to the ejector 110.

For reference, the first body 122 and the second bodies 124 may be coupled by a fastening member 140 such as a bolt and a nut as shown in FIG. 6.

Guiding members 130 and 131 may be positioned on the body 120. The guiding member of reference numeral 130 may be positioned at the rear based on a virtual line L-L dissecting the first body 122 and the guiding member of reference numeral 131 may be positioned at the front based on the virtual line L-L.

A guiding groove of reference numeral 134 is formed at the front 132 of the guiding member 130 and a guiding groove of reference numeral 135 is formed at the front 133 of the guiding member 131.

Herein, the guiding groove 134 of the guiding member 130 guides the ejector 110 to the mounting part 1222 disposed at the rear of the first body 122 and the guiding groove 135 of the guiding member 131 guides the ejector 110 to the mounting part 1222 disposed at the front of the first body 122 (see FIG. 7).

Meanwhile, the guiding member 130 may extend more longitudinally than the guiding member 131. Accordingly, a user can verify simultaneously the guiding grooves 134 and 135 respectively formed on the guiding members 130 and 131, in the front of the micro-ejecting apparatus 100.

The micro-ejecting apparatus 100 has a coupled form as shown in FIG. 6. The micro-ejecting apparatus 100 described above is used for a field in which complicated and various micro-ejections are required because the micro-ejecting apparatus 100 has the ejectors 110 provided in greater number than those of the first exemplary embodiment.

Further, the second exemplary embodiment of the present invention has the plurality of guiding members 130 and 131 having different extending lengths, such that the ejector 110 can be guided to exactly be mounted regardless of the formed position of the mounting parts 1222.

For reference, reference numeral 126 which is not described above is a fastening hole for connecting the body 120 to other equipments or a pipe connected with the inlet 1244.

### Third Exemplary Embodiment

Hereinafter, a micro-ejecting apparatus according to a third exemplary embodiment will be described with reference to FIG. 8. The micro-ejecting apparatus 100 according to the third exemplary embodiment has a different shape of the guiding groove 134 from the described exemplary embodiment. For reference, the same reference numerals refer to the same components of the exemplary embodiment as the above-described exemplary embodiments and a detailed description of the same components will be omitted.

The micro-ejecting apparatus 100 according to the third exemplary embodiment may include a guiding groove 134 having a changed cross-sectional size. A plurality of guiding grooves 134 are formed in the front of the guiding member 130 in a manner similar to that of the above-described exemplary embodiment. However, the guiding groove 134 of the third exemplary embodiment has a cross-sectional size gradually increasing from the upper end to the lower end of the guiding member 130 as shown in FIG. 8. For example, the guiding groove 134 has the same cross-sectional size as that of the mounting part 1222 at the upper end of the guiding member 130, but has a larger cross-sectional size than that of the upper end at the lower end of the guiding member 130.

The guiding groove 134 having a structure such as that described above may be more easily distinguished at the naked eye and the ejector 110 for the mounting part 1222 is more easily and exactly guided. Accordingly, the micro-ejecting apparatus 100 according to the third exemplary embodiment may be suitable to a relatively very thin or small ejector 110.

### Fourth Exemplary Embodiment

Hereinafter, a micro-ejecting apparatus according to a fourth exemplary embodiment will be described with reference to FIGS. 9 and 10. The micro-ejecting apparatus 100 according to the fourth exemplary embodiment has a different shape of the guiding member 130 from the described exemplary embodiments. For reference, the same reference numerals refer to the same components of the exemplary embodiment as the above-described exemplary embodiments and a detailed description of the same components will be omitted.

The micro-ejecting apparatus 100 according to the fourth exemplary embodiment may include a guiding member 130 having a slope. That is, the front 132 of the guiding member 130 is inclined in a rear-facing direction (+Y-axial direction) from the upper part to the lower part of the guiding member 130 as shown in FIG. 9.

The guiding member 130 can be distinguished at the naked eye in the front of the apparatus 100, such that the ejector 110 for the mounting part 1222 can be still guided. However, unlike the above-described embodiments, the ejector 110 having been mounted on the body 120 does not contact the guiding groove 134.

Therefore, in the fourth exemplary embodiment, since the ejector 110 mounted on the body 120 may be easily picked off as compared with the above-described embodiments, it is not required that the ejector 110 is manufactured longitudinally up to the lower end of the guiding member 130. Accordingly, the manufacturing cost of the ejector 110 can be reduced.

As set forth above, since the mounting position of the ejector is verified at the naked eye of user, the ejector can be easily and exactly mounted on the body of the micro-ejecting apparatus.

Further, the ejector may be easily mounted and exactly mounted, such that the damage generated in the mounting process of the ejector can be substantially reduced.

While the present invention has been shown and described in connection with the exemplary embodiments, it will be apparent to those skilled in the art that modifications and variations can be made without departing from the spirit and scope of the invention as defined by the appended claims.

What is claimed is:

1. A micro-ejecting apparatus, comprising:
an ejector including a channel therein and a driving part for ejecting a fluid to the outside;
a body including a plurality of mounting parts on which the ejectors are mounted; and
guiding members fixed on the body and having guide grooves corresponding to the plurality of mounting parts so as to determine the positions of the plurality of mounting parts in the body.

2. The micro-ejecting apparatus of claim 1, wherein the guiding groove is gradually larger toward the lower end from the upper end.

3. The micro-ejecting apparatus of claim 1, wherein the body includes a channel formed therein, for supplying the fluid to the ejector.

4. The micro-ejecting apparatus of claim 1, wherein the body further includes a fastening hole formed therein for fixing an external pipe connected with the channel.

5. The micro-ejecting apparatus of claim 1, wherein the ejector mounted on the mounting part protrudes outside of the guiding member.

6. The micro-ejecting apparatus of claim 1, wherein the body further includes a power supply substrate for supplying a current or a voltage to the driving part and a connection pin.

7. The micro-ejecting apparatus of claim 1, wherein the body includes: a first body including the plurality of mounting parts; and a second body connected to a fluid supply part supplying the fluid to the ejector.

8. The micro-ejecting apparatus of claim 1, wherein one side of the guiding member is inclined so as not to contact the ejector mounted on the mounting part.

9. The micro-ejecting apparatus of claim 1, wherein the mounting part further includes a fixing member installed thereon for supporting the ejector.

10. The micro-ejecting apparatus of claim 1, wherein the mounting part is a groove having a shape corresponding to the external shape of the ejector.

11. The micro-ejecting apparatus of claim 1, wherein the mounting part is opened toward the bottom of the body.

12. The micro-ejecting apparatus of claim 1, wherein an end of the ejector inserted into the mounting part and an end of the mounting part corresponding thereto are sharpened so as to align the ejector.
